(19) United States
(12) Patent Application Publication
(10) Pub. No.: US 2025/0326463 A1
(43) Pub. Date: Oct. 23, 2025

(54) SYSTEM AND METHOD FOR UPSHIFTING AND DOWNSHIFTING A BICYCLE TRANSMISSION SYSTEM

(71) Applicant: Classified Cycling BV, Antwerpen (BE)

(72) Inventor: Roëll Marie VAN DRUTEN, Eindhoven (NL)

(21) Appl. No.: 19/182,716

(22) Filed: Apr. 18, 2025

Related U.S. Application Data
(63) Continuation of application No. PCT/EP2024/060750, filed on Apr. 19, 2024.

(51) Int. Cl. B62M 25/08; B62M 9/122; B62M 11/18

(52) U.S. Cl. CPC B62M 25/08; B62M 9/122; B62M 11/18

(57) ABSTRACT

A method for upshifting a bicycle transmission system including a first transmission and a second transmission each having at least two different transmission ratios, and an actuation unit configured for, upon receiving an upshift input, upshifting the bicycle transmission according to an upshift sequence, wherein the upshift sequence comprises one or more coactive shifts of upshifting the bicycle transmission by coactively downshifting a first one of the first transmission and the second transmission and upshifting a second one of the first transmission and the second transmission. The method comprises, for one or more of the one or more coactive shifts of the upshift sequence, downshifting the first one of the first transmission and the second transmission and subsequently upshifting the second one of the first transmission and the second transmission.

### CLAIM FOR PRIORITY

This application is a continuation of and claims the benefit of priority of International Application No. PCT/EP2024/060750, filed Apr. 19, 2024, which is hereby incorporated by reference in its entirety.

### FIELD

The disclosure relates to a bicycle transmission system, particularly to methods for upshifting and downshifting a bicycle transmission system.

### BACKGROUND

Bicycle transmission systems may have multiple transmissions arranged in series. Some of these serially arranged transmissions may include gear shift mechanisms for shifting gears of the transmission; changing the transmission ratio of the transmission from one transmission ratio to another.

Some known bicycle transmission systems are shifted from one transmission ratio to another according to a synchronous shift step in which multiple transmissions of the system are shifted simultaneously. For example, a next-higher transmission ratio for the bicycle transmission system may involve a downshift with one of the transmissions and an upshift with another one of the transmissions, wherein the downshift and the upshift are executed synchronously.

For some bicycle transmission systems, however, there may be a noticeable time delay between initiation of the gear shift and the completion of the gear shift. This time delay may vary between different shift mechanisms, and may hence cause a synchronous shift step to feel out of sync by a rider of the bicycle. Moreover, in some shift mechanisms the time delay can be dependent on a state of the transmission system, causing the synchronous shift steps to feel out of sync in a random way.

### SUMMARY

It is an aim to propose a system and method for upshifting and downshifting a bicycle transmission system, in particular an improved system and method that overcomes or at least reduces some of the disadvantages of the prior art.

An aspect provides a method for upshifting a bicycle transmission system. The bicycle transmission system can be an internal bicycle hub transmission system. The bicycle transmission system can be an internal bicycle crank transmission system. The bicycle transmission system can be a combination of an internal bicycle hub transmission system and an internal crank transmission system. The bicycle transmission system can be an internal hub and/or crank transmission system in combination with a multi-ratio chain or belt transmission system. The multi-ratio chain or belt transmission system can be configured to move a chain or belt to a different size sprocket for changing a transmission ratio, e.g. by a derailleur or a moveable sprocket, or e.g. by a segmented chain/belt sprocket, or the like. The bicycle transmission system comprises a first transmission having at least two different transmission ratios, and a second transmission having at least two different transmission ratios. The first transmission and the second transmission are connected to each other in series to form a bicycle transmission that is selectively operable according to a plurality of different bicycle transmission ratios. The bicycle transmission system also comprises an actuation unit. The actuation unit can be a control unit. The actuation unit is configured for, upon receiving an upshift input, upshifting the bicycle transmission according to an upshift sequence. The upshift sequence comprises one or more coactive shifts of upshifting the bicycle transmission by coactively downshifting a first one of the first transmission and the second transmission and upshifting a second one of the first transmission and the second transmission. The method comprises, for one or more of the one or more (e.g. all) coactive shifts of the upshift sequence, downshifting, or at least triggering downshifting of, the first one of the first transmission and the second transmission and subsequently upshifting, or at least triggering upshifting of, the second one of the first transmission and the second transmission. Hence, for a coactive shift step that includes a downshift step and an upshift step, the downshift step is performed, or at least triggered, first and the upshift step is executed, or at least triggered, second. Hence, a time delay between activation of a clutch actuator and the actual gear shift can be accounted for, to provide a predictable and reliable coactive shift. A rider commanding an upshift, i.e. a change to a higher system transmission ratio, may shortly experience the downshift before being upshifted to the commanded system transmission ratio. This reduces the stress on the rider, in particular compared to the opposite sequence in which the rider would shortly experience a too large upshift before being downshifted to the commanded system transmission ratio.

Another aspect provides a method for downshifting a bicycle transmission system. The bicycle transmission system can be an internal bicycle hub transmission system. The bicycle transmission system can be an internal bicycle crank transmission system. The bicycle transmission system can be a combination of an internal bicycle hub transmission system and an internal crank transmission system. The bicycle transmission system can be an internal hub and/or crank transmission system in combination with a multi-ratio chain or belt transmission system. The multi-ratio chain or belt transmission system can be configured to move a chain or belt to a different size sprocket for changing a transmission ratio, e.g. by a derailleur or a moveable sprocket, or e.g. by a segmented chain/belt sprocket, or the like. The bicycle transmission system comprises a first transmission having at least two different transmission ratios, a second transmission having at least two different transmission ratios. The first transmission and the second transmission are connected to each other in series to form a bicycle transmission that is selectively operable according to a plurality of different bicycle transmission ratios. The bicycle transmission system also comprises an actuation unit. The actuation unit can be a control unit. The actuation unit is configured for, upon receiving a downshift input, downshifting the bicycle transmission according to a downshift sequence. The downshift sequence comprises one or more coactive shifts of downshifting the bicycle transmission by coactively downshifting a first one of the first transmission and the second transmission and upshifting a second one of the first transmission and the second transmission. The method comprises, for one or more (e.g. all) of the one or more coactive shifts of the downshift sequence, upshifting, or at least triggering upshifting of, the first one of the first transmission and the second transmission and subsequently downshifting, or at least triggering downshifting of, the second one of the first transmission and the second transmission. Hence, for a coactive shift step that includes a downshift step and an upshift step, the upshift step is performed first and the downshift step is executed second. Hence, a time delay between activation of a clutch actuator and the actual gear shift can hence be accounted for, to provide a predictable and reliable coactive shift. A rider commanding a downshift, i.e. a change to a lower system transmission ratio, may shortly experience an upshift before being downshifted to the commanded system transmission ratio. This can provide a balanced riding experience.

Optionally, the first one of the first transmission and the second transmission has a smaller transmission ratio step size between adjacent transmission ratios than the second one of the first transmission and the second transmission. Hence, in the upshift sequence, the coactive shift of upshifting the bicycle transmission comprises downshifting, or at least triggering downshifting of, the transmission having the smaller transmission ratio step size and subsequently upshifting, or at least triggering upshifting of, the transmission having the larger transmission ratio step size. Hence, in the downshift sequence, the coactive shift of upshifting the bicycle transmission comprises upshifting, or at least triggering upshifting of, the transmission having the smaller transmission ratio step size and subsequently downshifting, or at least triggering downshifting of, the transmission having the larger transmission ratio step size.

More in general can be provided a method for shifting a bicycle transmission system having a first transmission having at least two different transmission ratios, and a second transmission having at least two different transmission ratios, a step size between adjacent transmission ratios of the first transmission being smaller than a step size between adjacent transmission ratios of the second transmission, wherein the first transmission and the second transmission are connected to each other in series to form a bicycle transmission that is selectively operable according to a plurality of different bicycle transmission ratios, and an actuation unit configured for, upon receiving a shift input, shifting the bicycle transmission according to shift sequence, wherein the shift sequence comprises one or more coactive shifts of shifting the bicycle transmission by coactively downshifting a first one of the first transmission and the second transmission and upshifting a second one of the first transmission and the second transmission, the method comprising, for one or more of the one or more coactive shifts of the shift sequence, triggering the shifting of the first transmission and subsequently triggering the shifting of the second transmission.

Optionally, the first transmission has one or more first clutches and/or brakes for shifting the first transmission between at least two different transmission ratios, and one or more first actuators for actuating the one or more first clutches and/or brakes.

Optionally, the first transmission comprises one or more first planetary gear sets, each having at least three rotatable members.

Optionally, one of the one or more first clutches and/or brakes is configured for coupling a first rotatable member of one of the one or more first planetary gear sets with a second rotatable member of the one of the one or more first planetary gear sets.

Optionally, one of the one or more first clutches and/or brakes is configured for coupling a ring gear of one of the one or more first planetary gear sets with a planet carrier of the one of the one or more first planetary gear sets.

Optionally, one of the one or more first clutches and/or brakes is configured for coupling a third rotatable member of one of the one or more first planetary gear sets with a stationary member, such as an axle or a housing.

Optionally, one of the one or more first clutches and/or brakes is configured for coupling a sun gear of one of the one or more first planetary gear sets with a stationary axle, or for coupling a ring gear of one of the one or more first planetary gear sets with a stationary housing.

Optionally, the first transmission comprises one or more gear sets having parallel input and out axles.

Optionally, the second transmission has one or more second clutches and/or brakes for shifting the second transmission between at least two different transmission ratios, and one or more second actuators for actuating the one or more second clutches.

Optionally, the second transmission comprises one or more second planetary gear sets, each having at least three rotatable members.

Optionally, one of the one or more second clutches and/or brakes is configured for coupling a first rotatable member of one of the one or more second planetary gear sets with a second rotatable member of the one of the one or more second planetary gear sets.

Optionally, one of the one or more second clutches and/or brakes is configured for coupling a ring gear of one of the one or more second planetary gear sets with a planet carrier of the one of the one or more second planetary gear sets.

Optionally, one of the one or more second clutches and/or brakes is configured for coupling a third rotatable member of one of the one or more second planetary gear sets with a stationary member.

Optionally, one of the one or more second clutches and/or brakes is configured for coupling a sun gear of one of the one or more second planetary gear sets with a stationary axle, or for coupling a ring gear of one of the one or more second planetary gear sets with a stationary housing.

Optionally, the second transmission comprises one or more gear sets having parallel input and out axles.

Optionally, one of the first transmission and the second transmission comprises one or more rotatable clutches and/or brakes each configured for coupling a rotatable member with a further rotatable member, and one or more rotatable actuators for actuating the one or more rotatable clutches and/or brakes. The rotatable clutches and/or brakes can be actuated via the actuation unit.

Optionally, one of the first transmission and the second transmission comprises one or more stationary clutches and/or brakes each configured for coupling a rotatable member with a stationary member, and one or more stationary actuators for actuating the one or more stationary clutches and/or brakes. The stationary clutches and/or brakes can be actuated via the actuation unit.

Optionally, the method is arranged to perform both the upshifting and downshifting as described above.

Optionally, for the one or more of the one or more coactive shifts, the method comprises activating the one or more first actuators and activating the one or more second actuators, the activating of the one or more first actuators and the activating of the one or more second actuators being separated in time by a time interval. The shift sequence may include at least two coactive shifts, for example at least three coactive shifts. The method may comprise for at least two of the coactive shifts of the upshift sequence, for example for at least three of the coactive shifts of the upshift sequence, activating the one or more first actuators and activating the one or more second actuators, the activating of the one or more first actuators and the activating of the one or more second actuators being separated in time by a time interval. The method may comprise for at least two of the coactive shifts of the downshift sequence, for example for at least three of the coactive shifts of the downshift sequence, activating the one or more first actuators and activating the one or more second actuators, the activating of the one or more first actuators and the activating of the one or more second actuators being separated in time by a time interval. In an example, the method may comprise, for each coactive shift of the upshift sequence, activating the one or more first actuators and activating the one or more second actuators, the activating of the one or more first actuators and the activating of the one or more second actuators being separated in time by a time interval. In an example, the method may comprise, for each coactive shift of the downshift sequence, activating the one or more first actuators and activating the one or more second actuators, the activating of the one or more first actuators and the activating of the one or more second actuators being separated in time by a time interval.

The time interval between activations of the actuators may account for the time delay between the activations and the shift of the associated transmission. For example, the one or more actuators of the first of the first and second transmissions may be activated prior to the one or more actuators of the second of the first and second transmissions, or the one or more actuators of the second of the first and second transmissions may be activated prior to the one or more actuators of the first of the first and second transmissions, depending on the time delays. For example, the one or more first actuators may be activated prior to the one or more second actuators, or the one or more second actuators may be activated prior to the one or more first actuators, depending on the time delays.

The time interval may for example be determined based on the clutch and/or brake of the one or more clutches and/or brakes of the first one of the first and second transmissions having the largest time delay. Such clutch and/or brake may be denoted as the slowest responding clutch and/or brake. Which clutch and/or brake is the slowest responding clutch and/or brake may depend on the state of the bicycle transmission system. The time delay of a certain clutch and/or brake in the transmission system may for example depend on a rotational speed of its input and output, which in turn may depend on the position of the clutch and/or brake in the transmission system, and the transmission ratio according to which the transmission system is operated. Hence, the slowest responding clutch and/or brake may differ between different coactive shifts.

Optionally, the time interval between the activation of the one or more actuators of the first one of the first and second transmissions and the activation of the one or more actuators of the second one of the first and second transmissions is such that for the coactive shifts of the upshift sequence the first one of the first transmission and second transmission is downshifted, or at least triggered, before the second one of the first transmission and second transmission is upshifted, or at least triggered, and for the coactive shifts of the downshift sequence the first one of the first transmission and second transmission is upshifted, or at least triggered, before the second one of the first transmission and the second transmission is downshifted, or at least triggered. The time interval may hence correspond to a maximum time delay, or a portion thereof, between activation of a actuator and shifting of the associated transmission. The one or more actuators of the second one of the first transmission and second transmission may hence be activated when it can be reasonably expected that the first one of the first transmission and second transmission has shifted. The method may hence involve refraining from activating the one or more second actuators of the second one of the first transmission and second transmission, until the first one of the first transmission and second transmission is likely to have shifted. A sensor may for example detect that the first one of the first transmission and second transmission has shifted, and trigger the activation of the one or more actuators of the second one of the first transmission and second transmission. Additionally or alternatively, the maximum time delay may be estimated.

Optionally, the one or more actuators of the second one of the first transmission and second transmission is activated after the activation of the one or more actuators of the first one of the first transmission and second transmission, and wherein the time interval is equal to or longer than an a predetermined portion of a maximum time delay between the activation of the one or more actuators of the first one of the first transmission and second transmission and the downshift of the first transmission. The maximum time delay may for example be estimated, e.g. based on several parameters of the bicycle transmission system. The method may hence involve refraining from activating the one or more actuators of the second one of the first transmission and second transmission until the predetermined portion of the, e.g. estimated, maximum time interval has elapsed. For example, the one or more actuators of the second one of the first transmission and second transmission may be activated upon expiry of at least 50% of the maximum time interval. It may in this example be assumed that the first one of the first transmission and second transmission has shifted the majority of the cases.

Optionally, the one or more actuators of the second one of the first transmission and second transmission is activated after the activation of the one or more actuators of the first one of the first transmission and second transmission, and wherein the time interval is equal to or longer than the maximum time delay between the activation of the one or more actuators of the first one of the first transmission and second transmission and the downshift of the first transmission. It can hence be reasonably expected that the first transmission has shifted, prior to the second transmission.

Optionally, the time interval is determined based on an engagement index of the one or more first clutches and/or brakes and/or an engagement index of the one or more second clutches and/or brakes. Each clutch may be movable between an engaged state and a disengaged state. Clutch components may be in various different relative positions in the engaged state of a clutch. The possible different relative positions of the engaged state may define the engagement index of a clutch. Clutch components may hence require repositioning before assuming the engaged state. Such repositioning may hence be driven by a rotational motion of a transmission component.

Optionally, the time interval is predetermined and equal for all coactive shifts of the one or more coactive shifts. The time interval may for example be 1-150 ms.

According to an aspect is provided a method for shifting a bicycle transmission system comprising a first transmission having at least two different transmission ratios, and a second transmission having at least two different transmission ratios, a step size between adjacent transmission ratios of the first transmission being smaller than a step size between adjacent transmission ratios of the second transmission. The first transmission and the second transmission are connected to each other in series to form the bicycle transmission system that is selectively operable according to a plurality of different bicycle transmission ratios. The transmission system comprises an actuation unit configured for, upon receiving a shift input, shifting the bicycle transmission according to shift sequence, wherein the shift sequence comprises one or more coactive shifts of shifting the bicycle transmission by coactively downshifting a first one of the first transmission and the second transmission and upshifting a second one of the first transmission and the second transmission. The method comprises, for one or more of the one or more coactive shifts of the shift sequence, triggering the shifting of the first transmission and subsequently triggering the shifting of the second transmission.

According to an aspect is provided a method for shifting a bicycle transmission system comprising a first transmission having at least two different transmission ratios, and a second transmission having at least two different transmission ratios. The first transmission and the second transmission are connected to each other in series to form the bicycle transmission system that is selectively operable according to a plurality of different bicycle transmission ratios. The transmission system comprises an actuation unit configured for, upon receiving a shift input, shifting the bicycle transmission according to shift sequence, wherein the shift sequence comprises one or more coactive shifts of shifting the bicycle transmission by coactively downshifting a first one of the first transmission and the second transmission and upshifting a second one of the first transmission and the second transmission. The method comprises, for one or more of the one or more coactive shifts of an upshift sequence, triggering the downshifting before the upshifting, and/or for one or more of the one or more coactive shifts of a downshift sequence, triggering the upshifting before the downshifting.

According to an aspect is provided method for shifting a bicycle transmission system comprising a first transmission having at least two different transmission ratios, and a second transmission having at least two different transmission ratios. The first transmission and the second transmission are connected to each other in series to form the bicycle transmission system that is selectively operable according to a plurality of different bicycle transmission ratios. The transmission system comprises an actuation unit configured for, upon receiving a shift input, shifting the bicycle transmission according to shift sequence, wherein the shift sequence comprises one or more coactive shifts of shifting the bicycle transmission by coactively downshifting a first one of the first transmission and the second transmission and upshifting a second one of the first transmission and the second transmission. The method comprises, for one or more of the one or more coactive shifts of an upshift sequence, the downshifting transmission having a smaller transmission ratio step size between adjacent transmission ratios that the upshifting transmission, and/or for one or more of the one or more coactive shifts of a downshift sequence, the upshifting transmission having a smaller transmission ratio step size between adjacent transmission ratios that the downshifting transmission.

According to an aspect is provided a method for shifting a bicycle transmission system comprising a first transmission having at least two different transmission ratios, and a second transmission having at least two different transmission ratios. The first transmission and the second transmission are connected to each other in series to form the bicycle transmission system that is selectively operable according to a plurality of different bicycle transmission ratios. The transmission system comprises an actuation unit configured for, upon receiving a shift input, shifting the bicycle transmission according to shift sequence, wherein the shift sequence comprises one or more coactive shifts of shifting the bicycle transmission by coactively downshifting a first one of the first transmission and the second transmission and upshifting a second one of the first transmission and the second transmission. The method comprises, for one or more of the one or more coactive shifts of an upshift sequence, the downshifting transmission makes multiple smaller transmission ratio steps and the upshifting transmission makes one bigger transmission ratio step, and/or for one or more of the one or more coactive shifts of a downshift sequence, the upshifting transmission makes multiple smaller transmission ratio steps and the downshifting transmission makes one bigger transmission ratio step.

According to an aspect is provided a method for shifting a bicycle transmission system comprising a first transmission having at least two different transmission ratios, and a second transmission having at least two different transmission ratios. The first transmission and the second transmission are connected to each other in series to form the bicycle transmission system that is selectively operable according to a plurality of different bicycle transmission ratios. The transmission system comprises an actuation unit configured for, upon receiving a shift input, shifting the bicycle transmission according to shift sequence, wherein the shift sequence comprises one or more coactive shifts of shifting the bicycle transmission by coactively downshifting a first one of the first transmission and the second transmission and upshifting a second one of the first transmission and the second transmission. The method comprises, for one or more of the one or more coactive shifts of an upshift sequence, the downshifting transmission makes a single smaller transmission ratio step and the upshifting transmission makes a single bigger transmission ratio step, and/or for one or more of the one or more coactive shifts of a downshift sequence, the upshifting transmission makes a single smaller transmission ratio step and the downshifting transmission makes a single bigger transmission ratio step.

For all these aspects applies that the bicycle transmission system can be an internal bicycle hub transmission system, an internal bicycle crank transmission system, a combination of an internal bicycle hub transmission system and an internal crank transmission system, or an internal hub and/or crank transmission system in combination with a chain or belt transmission system.

For all these aspects the above options apply.

According to an aspect is provided a bicycle transmission system configured for executing a method as described hereinabove.

According to an aspect is provided a bicycle transmission system comprising a first transmission having at least two different transmission ratios, and a second transmission having at least two different transmission ratios. The first transmission and the second transmission are connected to each other in series to form a bicycle transmission that is selectively operable according to a plurality of different bicycle transmission ratios. The transmission system comprises an actuation unit. The actuation unit can be a control unit. The actuation unit is configured for, upon receiving an upshift input, upshifting the bicycle transmission according to an upshift sequence. The upshift sequence comprises one or more coactive shifts of upshifting the bicycle transmission by coactively downshifting a first one of the first transmission and the second transmission and upshifting a second one of the first transmission and the second transmission. The actuation unit is configured for, for one or more of the one or more coactive shifts of the upshift sequence, downshifting, or at least triggering downshifting of, the first one of the first transmission and the second transmission and subsequently upshifting, or at least triggering upshifting of, the second one of the first transmission and the second transmission.

According to an aspect is provided a bicycle transmission system comprising a first transmission having at least two different transmission ratios, and a second transmission having at least two different transmission ratios. The first transmission and the second transmission are connected to each other in series to form a bicycle transmission that is selectively operable according to a plurality of different bicycle transmission ratios. The transmission system comprises an actuation unit. The actuation unit can be a control unit. The actuation unit is configured for, upon receiving a downshift input, downshifting the bicycle transmission according to a downshift sequence. The downshift sequence comprises one or more coactive shifts of downshifting the bicycle transmission by coactively downshifting a first one of the first transmission and the second transmission and upshifting a second one of the first transmission and the second transmission. The actuation unit is configured for, for one or more of the one or more coactive shifts of the downshift sequence, upshifting, or at least triggering upshifting of, the first one of the first transmission and the second transmission and subsequently downshifting, or at least triggering downshifting of, the second one of the first transmission and the second transmission.

Optionally, the first one of the first transmission and the second transmission has a smaller transmission ratio step size between adjacent transmission ratios than the second one of the first transmission and the second transmission.

Optionally, the first transmission has one or more first clutches and/or brakes for shifting the first transmission between at least two different transmission ratios, and one or more first actuators for actuating the one or more first clutches and/or brakes.

Optionally, the first transmission comprises one or more first planetary gear sets, each having at least three rotatable members.

Optionally, one of the one or more first clutches and/or brakes is configured for coupling a first rotatable member of one of the one or more first planetary gear sets with a second rotatable member of the one of the one or more first planetary gear sets.

Optionally, one of the one or more first clutches and/or brakes is configured for coupling a ring gear of one of the one or more first planetary gear sets with a planet carrier of the one of the one or more first planetary gear sets.

Optionally, one of the one or more first clutches and/or brakes is configured for coupling a third rotatable member of one of the one or more first planetary gear sets with a stationary member.

Optionally, one of the one or more first clutches and/or brakes is configured for coupling a sun gear of one of the one or more first planetary gear sets with a stationary axle, or for coupling a ring gear of one of the one or more first planetary gear sets with a stationary housing.

Optionally, the second transmission has one or more second clutches and/or brakes for shifting the second transmission between at least two different transmission ratios, and one or more second actuators for actuating the one or more second clutches and/or brakes.

Optionally, the second transmission comprises one or more second planetary gear sets, each having at least three rotatable members.

Optionally, one of the one or more second clutches and/or brakes is configured for coupling a first rotatable member of one of the one or more second planetary gear sets with a second rotatable member of the one of the one or more second planetary gear sets.

Optionally, one of the one or more second clutches and/or brakes is configured for coupling a ring gear of one of the one or more second planetary gear sets with a planet carrier of the one of the one or more second planetary gear sets.

Optionally, one of the one or more second clutches and/or brakes is configured for coupling a third rotatable member of one of the one or more second planetary gear sets with a stationary member.

Optionally, one of the one or more second clutches and/or brakes is configured for coupling a sun gear of one of the one or more second planetary gear sets with a stationary axle, or for coupling a ring gear of one of the one or more second planetary gear sets with a stationary housing.

Optionally, one of the first transmission and the second transmission comprises one or more rotatable clutches and/or brakes each configured for coupling a rotatable member with a further rotatable member, and one or more rotatable h actuators for actuating the one or more rotatable clutches, e.g. via the actuation unit.

Optionally, the one of the first transmission and the second transmission comprises one or more stationary clutches and/or brakes each configured for coupling a rotatable member with a stationary member, and one or more stationary actuators for actuating the one or more stationary clutches, e.g. via the actuation unit.

Optionally, the actuation unit is further configured for, upon receiving a downshift input, downshifting the bicycle transmission according to a downshift sequence, e.g. by activating one or more of the first clutch actuators and/or one or more of the second clutch actuators. The downshift sequence comprises one or more coactive shifts of downshifting the bicycle transmission by coactively downshifting a first one of the first transmission and the second transmission and upshifting a second one of the first transmission and the second transmission. The actuation unit can be configured for, for one or more of the one or more coactive shifts of the downshift sequence, upshifting, or at least triggering upshifting of, the first one of the first transmission and the second transmission and subsequently downshifting, or at least triggering downshifting of, the second one of the first transmission and the second transmission.

Optionally, the first transmission comprises a first rotational input member, a first rotational output member and a first further rotational member, and is configured for transmitting torque according to an overdrive transmission ratio between the first rotational input member and the first rotational output member. The first transmission can further comprise a second rotational input member, a second rotational output member and a second further rotational member, and be configured for transmitting torque according to an underdrive transmission ratio between the second rotational input member and the second rotational output member. The first and second rotational input members can be corotatingly fixed to each other, and the first and second rotational output members can be corotatingly fixed to each other. The one or more first clutches and/or brakes can be arranged for selectively clutching at least one of the first further rotational member and the second further rotational member to a stationary part, for selectively transmitting torque through the first transmission or through the second transmission.

Optionally, the second transmission comprises a first rotational input member, a first rotational output member and a first further rotational member, and is configured for transmitting torque according to an overdrive transmission ratio between the first rotational input member and the first rotational output member. The second transmission can further comprise a second rotational input member, a second rotational output member and a second further rotational member, and be configured for transmitting torque according to an underdrive transmission ratio between the second rotational input member and the second rotational output member. The first and second rotational input members can be corotatingly fixed to each other, and the first and second rotational output members can be corotatingly fixed to each other. The one or more second clutches and/or brakes can be arranged for selectively clutching at least one of the first further rotational member and the second further rotational member to a stationary part, for selectively transmitting torque through the first transmission or through the second transmission.

According to an aspect is provided a bicycle transmission system comprising a first transmission having at least two different transmission ratios, and a second transmission having at least two different transmission ratios, a step size between adjacent transmission ratios of the first transmission being smaller than a step size between adjacent transmission ratios of the second transmission, wherein the first transmission and the second transmission are connected to each other in series to form the bicycle transmission system that is selectively operable according to a plurality of different bicycle transmission ratios, and an actuation unit configured for, upon receiving a shift input, shifting the bicycle transmission according to shift sequence, wherein the shift sequence comprises one or more coactive shifts of shifting the bicycle transmission by coactively downshifting a first one of the first transmission and the second transmission and upshifting a second one of the first transmission and the second transmission, wherein the actuation unit is configured for, for one or more of the one or more coactive shifts of the shift sequence, triggering the shifting of the first transmission and subsequently triggering the shifting of the second transmission.

According to an aspect is provided a bicycle transmission system comprising a first transmission having at least two different transmission ratios, and a second transmission having at least two different transmission ratios, wherein the first transmission and the second transmission are connected to each other in series to form the bicycle transmission system that is selectively operable according to a plurality of different bicycle transmission ratios, and an actuation unit configured for, upon receiving a shift input, shifting the bicycle transmission according to shift sequence, wherein the shift sequence comprises one or more coactive shifts of shifting the bicycle transmission by coactively downshifting a first one of the first transmission and the second transmission and upshifting a second one of the first transmission and the second transmission, wherein the actuation unit is configured for, for one or more of the one or more coactive shifts of an upshift sequence, triggering the downshifting before the upshifting, and/or for one or more of the one or more coactive shifts of a downshift sequence, triggering the upshifting before the downshifting.

According to an aspect is provided a bicycle transmission system comprising a first transmission having at least two different transmission ratios, and a second transmission having at least two different transmission ratios, wherein the first transmission and the second transmission are connected to each other in series to form the bicycle transmission system that is selectively operable according to a plurality of different bicycle transmission ratios, and an actuation unit configured for, upon receiving a shift input, shifting the bicycle transmission according to shift sequence, wherein the shift sequence comprises one or more coactive shifts of shifting the bicycle transmission by coactively downshifting a first one of the first transmission and the second transmission and upshifting a second one of the first transmission and the second transmission, wherein the actuation unit is configured for, for one or more of the one or more coactive shifts of an upshift sequence, the downshifting transmission having a smaller transmission ratio step size between adjacent transmission ratios that the upshifting transmission, and/or for one or more of the one or more coactive shifts of a downshift sequence, the upshifting transmission having a smaller transmission ratio step size between adjacent transmission ratios that the downshifting transmission.

According to an aspect is provided a bicycle transmission system comprising a first transmission having at least two different transmission ratios, and a second transmission having at least two different transmission ratios, wherein the first transmission and the second transmission are connected to each other in series to form the bicycle transmission system that is selectively operable according to a plurality of different bicycle transmission ratios, and an actuation unit configured for, upon receiving a shift input, shifting the bicycle transmission according to shift sequence, wherein the shift sequence comprises one or more coactive shifts of shifting the bicycle transmission by coactively downshifting a first one of the first transmission and the second transmission and upshifting a second one of the first transmission and the second transmission, wherein the actuation unit is configured for, for one or more of the one or more coactive shifts of an upshift sequence, the downshifting transmission makes multiple smaller transmission ratio steps and the upshifting transmission makes one bigger transmission ratio step, and/or for one or more of the one or more coactive shifts of a downshift sequence, the upshifting transmission makes multiple smaller transmission ratio steps and the downshifting transmission makes one bigger transmission ratio step.

According to an aspect is provided a bicycle transmission system comprising a first transmission having at least two different transmission ratios, and a second transmission having at least two different transmission ratios, wherein the first transmission and the second transmission are connected to each other in series to form the bicycle transmission system that is selectively operable according to a plurality of different bicycle transmission ratios, and an actuation unit configured for, upon receiving a shift input, shifting the bicycle transmission according to shift sequence, wherein the shift sequence comprises one or more coactive shifts of shifting the bicycle transmission by coactively downshifting a first one of the first transmission and the second transmission and upshifting a second one of the first transmission and the second transmission, wherein the actuation unit is configured for, for one or more of the one or more coactive shifts of an upshift sequence, the downshifting transmission makes a single smaller transmission ratio step and the upshifting transmission makes a single bigger transmission ratio step, and/or for one or more of the one or more coactive shifts of a downshift sequence, the upshifting transmission makes a single smaller transmission ratio step and the downshifting transmission makes a single bigger transmission ratio step.

For all these aspects, the options of the above bicycle transmission systems apply.

The bicycle transmission system of any of the aspects can be an internal bicycle hub transmission system, an internal bicycle crank transmission system, a combination of an internal bicycle hub transmission system and an internal crank transmission system, or an internal hub and/or crank transmission system in combination with a chain or belt transmission system.

According to an aspect is provided a human powered vehicle, such as a bicycle, or a light electric vehicle comprising a bicycle transmission system as described herein.

It will be appreciated that any of the aspects, features and options described herein can be combined. It will particularly be appreciated that any of the aspects, features and options described in view of the methods apply equally to the transmission systems, and vice versa.

### BRIEF DESCRIPTION OF THE DRAWINGS

Embodiments of the present invention will now be described in detail with reference to the accompanying drawings in which:

FIGS. 1, 2A, 2B and 3 show examples of a bicycle transmission system; and

FIG. 4 shows an example of a schematic representation of a method for shifting a bicycle transmission system.

### DETAILED DESCRIPTION

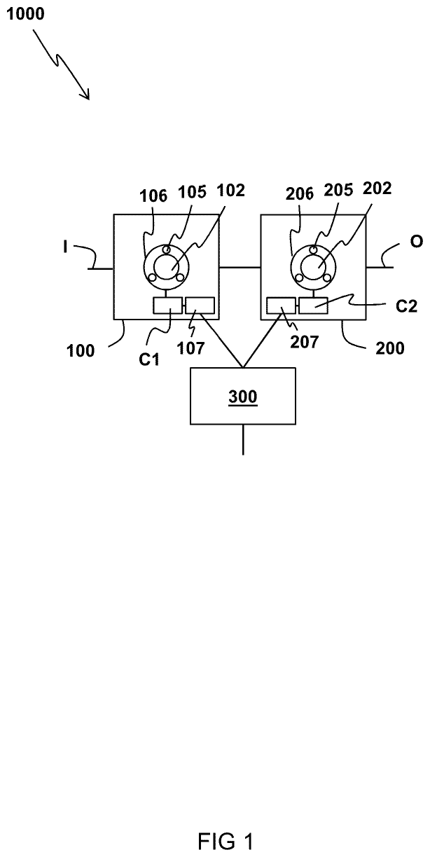

FIG. 1 shows an example of a bicycle transmission system 1000, having an system input I and a system output O, and comprising a first transmission 100 and a second transmission 200 between the system input I and the system output O. The first 100 and second 200 transmissions are connected to each other in series.

The first transmission 100 is selectively operable according to at least two transmission ratios. Here, the first transmission comprises a first clutch C1 for shifting the first transmission 100 from one transmission ratio to another, and vice versa. The first transmission 100 may include more than one clutch. In this example, the first transmission 100 comprises a planetary gear set with three rotatable members: a sun gear 102, a planet carrier carrying one or more planet gears 105 and a ring gear 106. The first clutch C1 may selectively rotationally couple or decouple two of the rotatable members, e.g. the planet carrier and the ring gear 106. The first clutch C1 may selectively couple or decouple, such as brake, a rotatable member with a stationary member, e.g. the sun gear 102 with a stationary axle or the ring gear 106 with a stationary housing.

The second transmission 200 is selectively operable according to at least two transmission ratios. Here, the second transmission 200 comprises a second clutch C2 for shifting the second transmission 200 from one transmission ratio to another, and vice versa. The second transmission 200 may comprise more than one clutch. In this example, the second transmission 200 also comprises a planetary gear set with three rotatable members: a sun gear 202, a planet carrier carrying one or more planet gears 205 and a ring gear 206. The second clutch C2 may selectively rotationally couple or decouple two of the rotatable members, e.g. the planet carrier and the ring gear 206. The second clutch C2 may selectively couple or decouple, such as brake, a rotatable member with a stationary member, e.g. the sun gear 202 with a stationary axle or the ring gear 206 with a stationary housing.

It will be appreciated that the first and second transmissions 100, 200 each having a planetary gear set is merely given as an example. The first or second transmission can e.g. be embodied as a multi-ratio chain or belt transmission system, e.g. configured to move a chain or belt to a different size sprocket for changing a transmission ratio, e.g. by a derailleur or a moveable sprocket, or e.g. by a segmented chain/belt sprocket, or the like. The bicycle transmission system 1000 can be an internal bicycle hub transmission system, the first and second transmissions 100, 200 forming part of the internal bicycle hub transmission system. The bicycle transmission system 1000 can be an internal bicycle crank transmission system, the first and second transmissions 100, 200 forming part of the internal bicycle crank transmission system. The bicycle transmission system 1000 can be a combination of an internal bicycle hub transmission system and an internal crank transmission system, e.g. one of the first and second transmissions 100, 200 forming part of the internal bicycle crank transmission system and the other of the first and second transmissions 100, 200 forming part of the internal bicycle hub transmission system. The bicycle transmission system 1000 can be an internal hub and/or crank transmission system in combination with a multi-ratio chain or belt transmission system, e.g. one of the first and second transmissions 100, 200 forming part of the internal hub and/or crank transmission system and the other of the first and second transmissions 100, 200 forming part of the multi-ratio chain or belt transmission system.

The first clutch C1 and the second clutch C2 are substantially identical in this example. Here, each of the one or more first and second clutches C1, C2 can comprise a rotatable clutch or a brake clutch. The one or more rotatable clutches are configured for selectively coupling or decoupling two rotatable members. The one or more brake clutches are configured for selectively coupling or decoupling a rotatable member with a stationary member. Here, the first clutch C1 and the second clutch C2 are form-closed clutches, configured to be coupled and decoupled under load. An example of a suitable rotatable clutch for coupling two rotatable members for the first and second clutch is described in WO2018/199757A2, WO2020/085911A2, or WO2021/080431A1, incorporated herein by reference. A brake clutch is suitable for, in the coupled state, blocking rotational movement between the thereby coupled rotatable and stationary members in at least one direction of rotation.

The system also comprises an actuation unit 300. The actuation unit can be a control unit. The actuation unit 300 is arranged for receiving a shift input signal, e.g. an upshift and/or a downshift input, from an operating device such as a remote manually operable shifter. The shift input can be a shift signal, such as a wired or wireless electronic signal. The shift input can be a mechanical input, such as movement of a cable or lever. The operating device may be manually operable by a user while riding the bicycle, and may for instance be conveniently provided at a handlebar of the bicycle.

Here, the actuation unit 300 is operatively connected to a first actuator 107 associated with the first clutch C1, and a second actuator 207 associated with the second clutch C2. The actuation unit 300 is configured to change the system transmission ratio, i.e. the transmission ratio between the input I and the output O of the bicycle transmission system, in response to receiving the shift signal. The actuation unit 300 is in this example particularly configured to, in response to receiving a shift signal, activating the first actuator 107 and/or the second actuator 207. The activation of the first clutch C1 and/or the second clutch C2 causes the first clutch C1 and/or the second clutch 102 to move between a decoupled state and a decoupled state, which in turn effects the first transmission 100 and/or the second transmission 200 to shift.

The system transmission ratio may be upshifted to a higher system transmission ratio in response to receiving an upshift input. The system transmission ratio may be downshifted to a lower system transmission ratio in response to receiving a downshift input. Upshifting through the system transmission ratios may be executed in accordance with an upshift sequence. Similarly, downshifting through the system transmission ratios may be executed in accordance with a downshift sequence. The upshift sequence can include all bicycle transmission ratios consecutively, or a subset of the bicycle transmission systems. The downshift sequence can include all bicycle transmission ratios consecutively, or a subset of the bicycle transmission ratios.

The upshift sequence and/or the downshift sequence may be predefined, and pre-programmed into the actuation unit 300. The actuation unit 300 for instance comprises a memory with stored therein a look-up table of the upshift sequence and/or the downshift sequence. The upshift sequence and/or the downshift sequence may be identical but in reverse. In other words, a path of upshifting through the bicycle transmission ratios may the same as a path of downshifting through the bicycle transmission ratios, but in reverse order.

The upshift sequence and/or the downshift sequence may include one or more coactive shifts of coactively changing the transmission ratio of the first transmission 100 and the transmission ratio of the second transmission 200, so as to change the system transmission ratio between the input I and the output O. Hence, in a coactive shift step, the first 100 and second 200 transmission coactively change their respective transmission ratio, so as upshift or downshift the transmission system 1000.

The upshift sequence and/or downshift sequence may also include non-coactive shift steps of selectively changing either the transmission ratio of the first transmission 100 or the transmission ratio of the second transmission 200. Hence, in the non-coactive shift step, the current transmission ratio of one of the first 100 and second 200 transmissions is maintained, whereas the other one of the first 100 and second 200 transmissions is changed.

The upshift sequence may include multiple coactive shifts of the transmission system 1000. At least some of these coactive shifts of the upshift sequence may include a downshift, or at least triggering of a downshift, of a first one the first transmission 100 and the second transmission 200 and a subsequent upshift, or at least triggering of an upshift, of a second one of the first transmission 100 and the second transmission 200.

Similarly, the downshift sequence may include multiple coactive shifts of the transmission system 1000. At least some of these coactive shifts of the downshift sequence may include an upshift, or at least triggering of an upshift, of a first one the first transmission 100 and the second transmission 200 and a subsequent downshift, or at least triggering of a downshift, of a second one of the first transmission 100 and the second transmission 200.

The first one of the first transmission and the second transmission can have a smaller transmission ratio step size between adjacent transmission ratios than the second one of the first transmission and the second transmission.

A coactive shift of the upshift and downshift sequence of the transmission system 1000 will now be explained in view of an example in which a coactive shift of the upshift sequence involves a downshift of the first transmission 100 and upshift of the second transmission 200 and in which a coactive shift of the downshift sequence involves an upshift of the first transmission 100 and a downshift of the second transmission 200.

Here, in the coactive shift of the upshift sequence, the first transmission 100 is downshifted first, and the second transmission 200 is upshifted thereafter. Hereto, the actuation unit 300 activates the first actuator 107, e.g. by transmitting a downshift input to the first actuator 107, and subsequently activates the second actuator 207, e.g. by transmitting an upshift input to the second actuator 207. The activation of the first actuator 107 and the second actuator 207 may hence be separated from one another in time by a time interval. The time interval may be such that the first transmission 100 has shifted. Hence, the second actuator 207 may be activated by the actuation unit 300, only after the first transmission 100 has downshifted.

In this example, in the coactive shift of the downshift sequence, the first transmission 100 is upshifted first, and the second transmission 200 is downshifted thereafter. Hereto, the actuation unit 300 activates the first actuator 107, e.g. by transmitting an upshift signal to the first actuator 107, and subsequently activates the second actuator 207, e.g. by transmitting a downshift input to the second actuator 207. The activation of the first actuator 107 and the second actuator 207 may hence be separated from one another in time by a time interval. The time interval may be such that the first transmission 100 has shifted. Hence, the second actuator 207 may be activated by the actuation unit 300, only after the first transmission 100 has upshifted.

The time interval may be determined based on a maximum time delay between the firstly activated clutch actuator and the following performance of the gear shift.

For example, in view of the upshift sequence, the time interval may be determined based on a maximum time delay between activation of the first actuator 107 and the downshift of the first transmission 100. This maximum time delay may be estimated, for example based on an engagement index of the first clutch C1, a speed of the bicycle and a current transmission system transmission ratio. For example, the engagement index of a clutch may be such that an engagement or disengagement of the clutch at most requires a certain angular displacement of an input of the clutch. Based on a rotational speed of the clutch input, it can be estimated what the maximum time delay may be.

The time interval may for example be set equal to the maximum time delay. Hence, it can be reasonably expected that the first transmission 100 has shifted. A sensor may for example be arranged for detecting whether the first transmission 100 has shifted, and trigger the activation of the second actuator 207. The maximum time delay may also be estimated, e.g. determined experimentally.

The time interval also be set as a portion of the maximum time delay. The time interval may also be such that the first transmission 100 has shifted in a majority of cases. The maximum time delay may for example be considered a random variable of a uniform distribution on an interval between zero and the, e.g. estimated, maximum time delay. The second clutch actuator 207 may accordingly be activated after expiry of a portion of the maximum time delay, particularly such that the probability that the first transmission 100 has shifted is larger than 0.5, more particularly larger than 0.8. For example, the second actuator 207 may be activated after expiry of half the maximum time delay. This way, the time difference between the downshift, here of the first transmission 100, and the upshift, here of the second transmission, may hence be minimized on average.

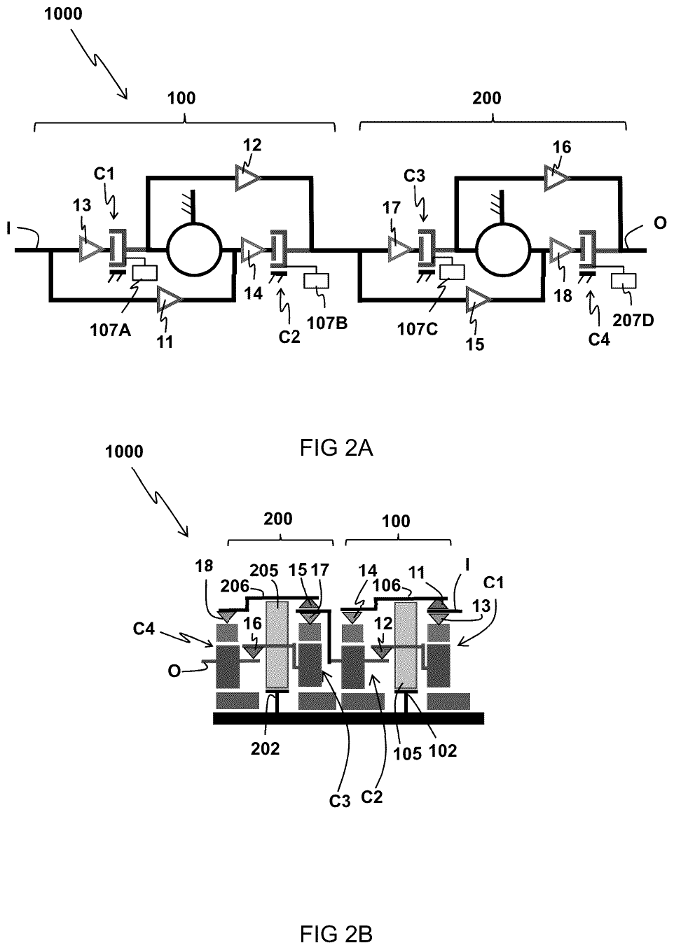

FIGS. 2A and 2B show another example of a bicycle transmission system 1000, particularly a nine-speed transmission system comprising two three-speed planetary transmissions 100, 200 connected to each other in series.

The first transmission 100 includes two clutches C1, C2, a first freewheel 11, a second freewheel 12, an optional third freewheel 13, and an optional fourth freewheel 14. The second transmission 200 includes a two clutches C3, C4, a fifth freewheel 15, a sixth freewheel 16, an optional seventh freewheel 17, and an optional eighth freewheel 18.

Any of the nine transmission ratios of the nine-speed transmission system 1000 can be selected using only four clutches C1, C2, C3, C4. Here the four clutches are identical to each other, and for example similar to a clutch as described in WO2018/199757A2, WO2020/085911A2, or WO2021/080431A1. All of the clutches C1-C4 are, here, independently actuatable using. Hence, the system can directly change from one transmission ratio to any other system transmission ratio, without having to go through intermediate transmission ratios. For example, the transmission system may change from a largest of the, here, nine transmission ratios directly to a smallest of the, here, nine transmission ratios, without having to go through any of the intermediate transmission ratios between the smallest and largest.

Table 1 shows an example of transmission ratios obtainable with the nine-speed planetary transmission of FIG. 2, and the associated clutch states. Table 1 may hence be considered a shift sequence of the transmission system 1000. The first transmission 100 is in this example selectively operable according to transmission ratios R1, R2, and R3, wherein R1=1.14, R2=1.00 and R3=0.88. The second transmission is selectively operable according to transmission ratios R4, R5, and R6, wherein R4=1.48, R5=1.00 and R6=0.67. It will be appreciated that a transmission ratio step size of the first transmission is smaller than a transmission ratio step size of the second transmission.

TABLE 1

| | C1 | C2 | C3 | C4 | Ratio | Step |
|---|---|---|---|---|---|---|
| 1 | decoupled | decoupled | decoupled | decoupled | 0.59 | 1.14 |
| 2 | decoupled | coupled | decoupled | decoupled | 0.67 | 1.14 |
| 3 | coupled | coupled | decoupled | decoupled | 0.77 | 1.14 |
| 4 | decoupled | decoupled | decoupled | coupled | 0.88 | 1.14 |
| 5 | decoupled | coupled | decoupled | coupled | 1.00 | 1.14 |
| 6 | coupled | coupled | decoupled | coupled | 1.14 | 1.14 |
| 7 | decoupled | decoupled | coupled | coupled | 1.30 | 1.14 |
| 8 | decoupled | coupled | coupled | coupled | 1.48 | 1.14 |
| 9 | coupled | coupled | coupled | coupled | 1.69 | 1.14 |
| | | | | | 285% | |

In this example, the coactive shift may include a coupling and decoupling of more than two clutches. For example, upshifting from the 3^{rd} to the 4^{th} system transmission ratio, involves a coactively downshifting the first transmission 100 by actuation of clutch C1 and clutch C2 of the first transmission 100, and upshifting the second transmission 200 by actuating clutch C4 of the second transmission 200. Conversely, downshifting from the 4^{th} to the 3^{rd} system transmission ratio, involves a coactively upshifting the first transmission 100 by actuation of clutch C1 and clutch C2 of the first transmission 100, and downshifting the second transmission 200 by actuating clutch C4 of the second transmission 200. In the upshift sequence, the first transmission 100 may be downshifted first, and the second transmission 200 may be upshifted thereafter, e.g. after expiry of time interval. In the downshift sequence, the second transmission 200 may be upshifted first, and the first transmission 100 may be downshifted thereafter, e.g. after expiry of time interval. Another, similar, coactive shift is to be performed between the 6th to the 7th system transmission ratio.

In this example, for the coactive shifts, the time interval may be based on the maximum time delay of the slowest responding clutch of the first transmission. In this example, the downshift with the first transmission 100 involves transitioning clutches C1 and C2 from a coupled state to a decoupled state. In this example, the upshift with the first transmission 100 involves transitioning clutches C1 and C2 from a decoupled state to a coupled state. Also in this example, the clutches C1-C4 are so configured that transitioning from the coupled state to the decoupled state is quicker than transitioning from the decoupled state to the coupled state.

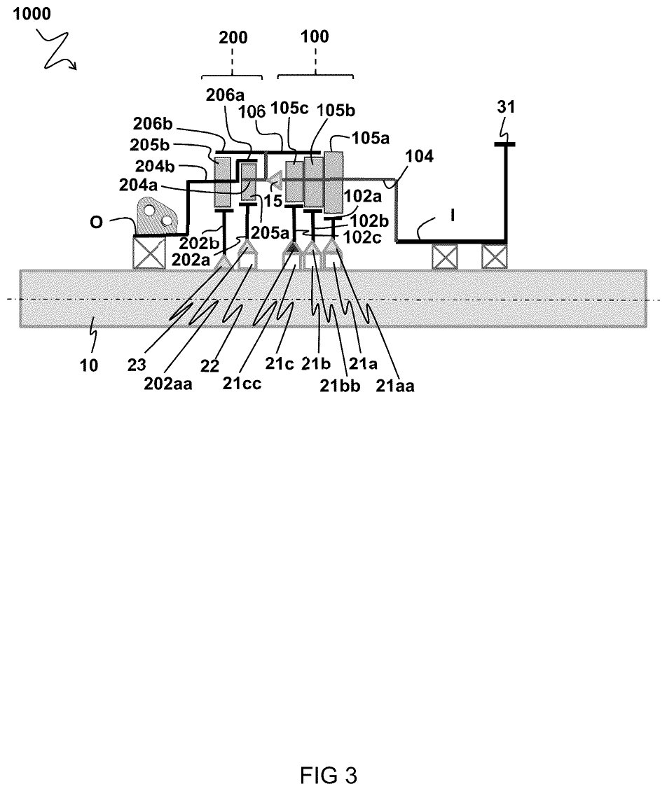

FIG. 3 shows an example of a bicycle transmission system 1000, comprising the first and second planetary transmissions 100, 200. The first planetary transmission 100 and the second planetary transmission 200 are respectively selectively operable according to multiple different overdrive and/or underdrive transmission ratios. The first planetary transmission 100 is arranged in series with the second planetary transmission 200. The first planetary transmission 100 is here arranged upstream of the second planetary transmission 200. The first planetary transmission 100 is arranged to be selectively operated according to a plurality of different transmission ratios, here four different transmission ratios. The first planetary transmission 100 is particularly arranged to be selectively operated according to three overdrive transmission ratios and an unitary transmission ratio. Hence, here, the bicycle transmission system 1000 may provide an eight-speed transmission system.

The first planetary transmission 100 includes multiple, here, three, first sun gears 102a, 102b, 102c, a first planet carrier 104 carrying one or more stepped first planet gears 105, and a first ring gear 106. Each first sun gear 102a, 102b, 102c is selectively clutchable to a stationary axle 10 with a respective first, clutches 21a, 21b, 21c. Each first planet gear 105 includes multiple, here three, different radii 105a, 105b, 105c. Each radius 105a, 105b, 105c meshes with a respective first sun gear 102a, 102b, 102c. The first ring gear 106 meshes with a single radius 105b of the stepped first planet gears 105. The first planet carrier 104 forms a first rotatable input member of the first planetary transmission 100. The first ring gear 106 forms a first rotatable output member of the first planetary transmission 100. The first planet carrier 104 is clutchable to the first ring gear 106 in one relative rotation direction by a passive clutch 15, e.g. a freewheel clutch, for providing a unitary transmission ratio with the first planetary transmission 100. In this example, between the respective sun gears 102a, 102b, 102c and the stationary axle 10 also respective freewheel clutches 21aa, 21bb, 21cc are arranged, each in series with the respective active clutches 21a, 21b, 21c.

The second planetary transmission 200 includes multiple, here, two, second sun gears 202a, 202b, a second planet carrier 204a carrying one or more second planet gears 205a, a third planet carrier 204b carrying one or more third planet gears 205b, a second ring gear 206a and a third ring gear 206b. Here, the largest sun gear 202a, is selectively clutchable to the stationary axle 10 with a second active clutch 22, while the smallest sun gear 202b is clutchable to the stationary axle 10 by the passive fifth clutch 23. In this example, between the respective sun gear 202a and the stationary axle 10 also freewheel clutch 202aa bis arranged, in series with the respective active clutch 22a. The first ring gear 106 is corotatingly fixed to the second planet carrier 204a and the third ring gear 206b. The third ring gear 206b and the first ring gear 106 have in this example the same radius. The third ring gear 206b and the first ring gear 106 may for example be integrated as a single-radius bus.

Table 2 shows an example of transmission ratios obtainable with the eight-speed planetary transmission of FIG. 3. Table 2 may hence be considered another shift sequence of the transmission system 1000. The first transmission 100 is in this example selectively operable according to four transmission ratios R7, R8, R9 and R10, wherein in this example R7=1.00, R8=1.22, R9=1.49 and R10=1.82. The second transmission is selectively operable according to transmission ratios R11 and R12, wherein in this example R11=0.70 and R12=1.55.

TABLE 2

| | T1 | T2 | Ratio | Step |
|---|---|---|---|---|
| 1 | 1.00 | 0.70 | 0.70 | |
| 2 | 1.22 | 0.70 | 0.85 | 1.22 |
| 3 | 1.49 | 0.70 | 1.04 | 1.22 |
| 4 | 1.82 | 0.70 | 1.27 | 1.22 |
| 5 | 1.00 | 1.55 | 1.55 | 1.22 |
| 6 | 1.22 | 1.55 | 1.89 | 1.22 |
| 7 | 1.49 | 1.55 | 2.31 | 1.22 |
| 8 | 1.82 | 1.55 | 2.82 | 1.22 |
| | | | 402% | |

Here, the shifting between the 1st and the 4th system transmission ratios (e.g. 1^{st}-2^{nd}, 2^{nd}-3^{rd}, 3^{rd}-4^{th} 1^{st}-3^{rd}, 1^{st}-4^{th}, or 2^{nd}-4^{th}) as well as between the 5th and the 8th system transmission ratios (e.g. 5^{th}-6^{th}, 6^{th}-7^{th}, 7^{th}-8^{th}, 5^{th}-7^{th}, 5^{th}-8^{th}, or 6^{th}-8^{th}) includes actuation of one active clutch at each shift between two consecutive system transmission ratios. Therefore, upshifts and downshifts between the 1st and the 4th system transmission ratios and between the 5th and the 8th system transmission ratios do not include a coactive shift of the first transmission system 100 and the second transmission system 200. Here, shifting between the 4th and the 5th system transmission ratio involves a coactive shift of the first and second transmission systems 100, 200.

In this example, the coactive shift may include a coupling and decoupling of more than two clutches. For example, upshifting from the 4th to the 5th system transmission ratio, involves a coactively downshifting the first transmission 100 by actuation of active first clutches 21a, 21b, 21c of the first transmission 100 to a decoupled state, and upshifting the second transmission 200 by actuating active second clutch 22 of the second transmission 200 to a coupled state. Conversely, downshifting from the 5th to the 4th system transmission ratio, involves a coactively upshifting the first transmission 100 by actuation of at least active first clutch 21c of the first transmission 100 to the coupled state, and downshifting the second transmission 200 by actuating active second clutch 22 of the second transmission 200 to the decoupled state. In the upshift sequence, the first transmission 100 may be downshifted first, and the second transmission 200 may be upshifted thereafter, e.g. after expiry of time interval. In the downshift sequence, the second transmission 200 may be upshifted first, and the first transmission 100 may be downshifted thereafter, e.g. after expiry of time interval.

In this example, for the coactive shifts, the time interval may be based on the maximum time delay of the slowest responding clutch of the first transmission. In this example, the downshift with the first transmission 100 involves transitioning active first clutches 21a, 21b, 21c from a coupled state to a decoupled state. In this example, the upshift with the first transmission 100 involves transitioning at least active first clutch 21c from a decoupled state to a coupled state. Also in this example, the clutches 21a, 21b, 21c, 22 are so configured that transitioning from the coupled state to the decoupled state is quicker than transitioning from the decoupled state to the coupled state.

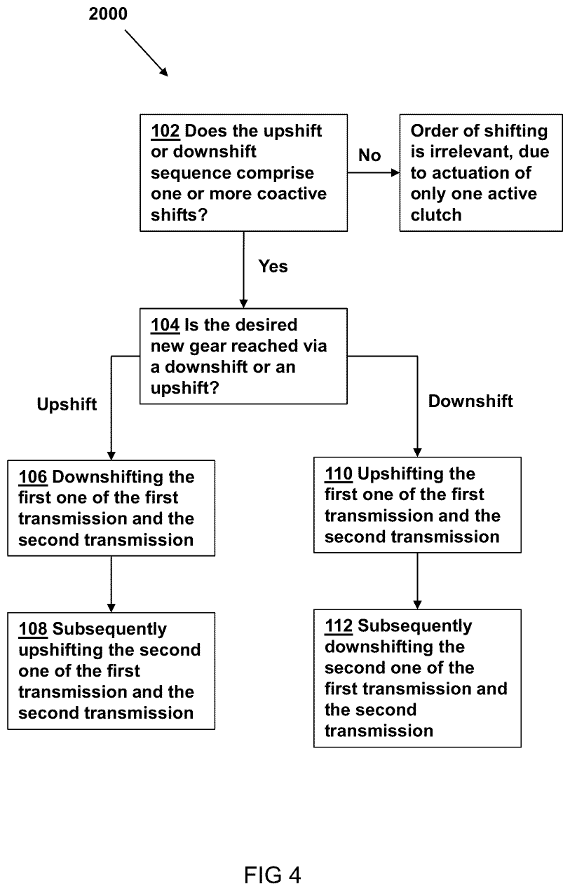

FIG. 4 shows an example of a method 2000 for upshifting and/or downshifting an internal bicycle hub and/or crank transmission system 1000. In step 102, it is determined whether the upshift sequence or downshift sequence comprises one or more coactive shifts. If a shift sequence doesn't comprise coactive shift steps, the shift sequence does not fall within the scope of the claims as the shifting order is irrelevant due to actuation of only one active clutch. If a shift sequence comprises one or more coactive shift steps, the following step is determining whether the desired new gear is reached via a downshift or an upshift in step 104. In case the desired new gear is reached through an upshift, the first one of the first transmission and the second transmission is downshifted first in step 106. Subsequently, in step 108, the second one of the first transmission and the second transmission is upshifted. In case the desired new gear is reached through a downshift, the first one of the first transmission and the second transmission is upshifted first in step 110. Subsequently, in step 112, the second one of the first transmission and the second transmission is downshifted.

Herein, the invention is described with reference to specific examples of embodiments of the invention. It will, however, be evident that various modifications and changes may be made therein, without departing from the essence of the invention. For the purpose of clarity and a concise description features are described herein as part of the same or separate embodiments, however, alternative embodiments having combinations of all or some of the features described in these separate embodiments are also envisaged.

However, other modifications, variations, and alternatives are also possible. The specifications, drawings and examples are, accordingly, to be regarded in an illustrative sense rather than in a restrictive sense.

In the claims, any reference signs placed between parentheses shall not be construed as limiting the claim. The word ‘comprising’ does not exclude the presence of other features or steps than those listed in a claim. Furthermore, the words ‘a’ and ‘an’ shall not be construed as limited to ‘only one’, but instead are used to mean ‘at least one’, and do not exclude a plurality. The mere fact that certain measures are recited in mutually different claims does not indicate that a combination of these measures cannot be used to an advantage.

1. A method for upshifting a bicycle transmission system being:
(a) an internal bicycle hub transmission system or
(b) an internal bicycle crank transmission system or
(c) a combination of an internal bicycle hub transmission system and an internal crank transmission system or
(d) an internal bicycle hub and/or crank transmission system in combination with a multi-ratio chain or belt transmission system,
wherein the bicycle transmission system comprises:
a first transmission having at least two different transmission ratios,
a second transmission having at least two different transmission ratios,
wherein the first transmission and the second transmission are connected to each other in series to form a bicycle transmission that is selectively operable according to a plurality of different bicycle transmission ratios, and
an actuation unit configured for, upon receiving an upshift input, upshifting the bicycle transmission according to an upshift sequence,
wherein the upshift sequence comprises one or more coactive shifts of upshifting the bicycle transmission by coactively downshifting a first one of the first transmission and the second transmission and upshifting a second one of the first transmission and the second transmission,
the method comprising, for one or more of the one or more coactive shifts of the upshift sequence, downshifting, or at least triggering downshifting of, the first one of the first transmission and the second transmission and subsequently upshifting, or at least triggering downshifting of, the second one of the first transmission and the second transmission.

2. A method for downshifting a bicycle transmission system being:
(a) an internal bicycle hub transmission system or
(b) an internal bicycle crank transmission system or
(c) a combination of an internal bicycle hub transmission system and an internal crank transmission system or
(d) an internal hub and/or crank transmission system in combination with a multi-ratio chain or belt transmission system,
wherein the bicycle transmission system comprises:
a first transmission having at least two different transmission ratios,
a second transmission having at least two different transmission ratios,
wherein the first transmission and the second transmission are connected to each other in series to form a bicycle transmission that is selectively operable according to a plurality of different bicycle transmission ratios, and
an actuation unit configured for, upon receiving a downshift input, downshifting the bicycle transmission according to a downshift sequence,
wherein the downshift sequence comprises one or more coactive shifts of downshifting the bicycle transmission by coactively downshifting a first one of the first transmission and the second transmission and upshifting a second one of the first transmission and the second transmission,
the method comprising, for one or more of the one or more coactive shifts of the downshift sequence, upshifting, or at least triggering upshifting of, the first one of the first transmission and the second transmission and subsequently downshifting, or at least triggering downshifting of, the second one of the first transmission and the second transmission.

3. The method of claim 1, wherein the first one of the first transmission and the second transmission has a smaller transmission ratio step size between adjacent transmission ratios than the second one of the first transmission and the second transmission.

4. The method of claim 1, wherein the first transmission has one or more first clutches an/or brakes for shifting the first transmission between at least two different transmission ratios, and one or more first actuators for actuating the one or more first clutches and/or brakes.

5. The method of claim 4, wherein the first transmission comprises one or more first planetary gear sets, each having at least three rotatable members, optionally wherein one of the one or more first clutches and/or brakes is configured for coupling a first rotatable member of one of the one or more first planetary gear sets with a second rotatable member of the one of the one or more first planetary gear sets, further optionally wherein one of the one or more first clutches and/or brakes is configured for coupling a ring gear of one of the one or more first planetary gear sets with a planet carrier of the one of the one or more first planetary gear sets.

6.-7. (canceled)

8. The method of claim 5, wherein one of the one or more first clutches and/or brakes is configured for coupling a third rotatable member of one of the one or more first planetary gear sets with a stationary member, optionally wherein one of the one or more first clutches and/or brakes is configured for coupling a sun gear of one of the one or more first planetary gear sets with a stationary axle, or for coupling a ring gear of one of the one or more first planetary gear sets with a stationary housing.

9. (canceled)

10. The method of claim 4, wherein the first transmission comprises one or more gear sets having parallel input and out axles.

11. The method of claim 4, wherein the second transmission has one or more second clutches and/or brakes for shifting the second transmission between at least two different transmission ratios, and one or more second actuators for actuating the one or more second clutches and/or brakes.

12. The method of claim 11, wherein the second transmission comprises one or more second planetary gear sets, each having at least three rotatable members.

13. The method of claim 12, wherein one of the one or more second clutches and/or brakes is configured for coupling a first rotatable member of one of the one or more second planetary gear sets with a second rotatable member of the one of the one or more second planetary gear sets, optionally wherein one of the one or more second clutches and/or brakes is configured for coupling a ring gear of one of the one or more second planetary gear sets with a planet carrier of the one of the one or more second planetary gear sets.

14. (canceled)

15. The method of claim 12, wherein one of the one or more second clutches and/or brakes is configured for coupling a third rotatable member of one of the one or more second planetary gear sets with a stationary member, optionally wherein one of the one or more second clutches and/or brakes is configured for coupling a sun gear of one of the one or more second planetary gear sets with a stationary axle, or for coupling a ring gear of one of the one or more second planetary gear sets with a stationary housing.

16.-17. (canceled)

18. The method of claim 4, wherein one of the first transmission and the second transmission comprises one or more rotatable clutches and/or brakes each configured for coupling a rotatable member with a further rotatable member, and one or more rotatable actuators for actuating the one or more rotatable clutches and/or brakes, and/or wherein one of the first transmission and the second transmission comprises one or more stationary clutches and/or brakes each configured for coupling a rotatable member with a stationary member, and one or more stationary actuators for actuating the one or more stationary clutches and/or brakes.

19. (canceled)

20. The method of claim 1, wherein the actuation unit is further configured for, upon receiving a downshift input, downshifting the bicycle transmission according to a downshift sequence,
wherein the downshift sequence comprises one or more coactive shifts of downshifting the bicycle transmission by coactively downshifting a first one of the first transmission and the second transmission and upshifting a second one of the first transmission and the second transmission.
the method comprising, for one or more of the one or more coactive shifts of the downshift sequence, upshifting, or at least triggering upshifting of, the first one of the first transmission and the second transmission and subsequently downshifting, or at least triggering downshifting of, the second one of the first transmission and the second transmission.

21. The method of claim 11, wherein for one or more of the one or more coactive shifts and/or downshifts, the method comprises activating the one or more actuators of the first one of the first transmission and the second transmission and activating the one or more actuators of the second one of the first transmission and the second transmission, the activating of the one or more first actuators of the first one of the first transmission and the second transmission and the activating of the one or more second actuators of the second one of the first transmission and the second transmission being separated in time by a time interval.

22.-24. (canceled)

25. The method of claim 21, wherein the time interval is determined based on an engagement index of the one or more first clutches and/or brakes and/or an engagement index of the one or more second clutches and/or brakes, and/or wherein the time interval is predetermined and equal for all coactive shifts of the one or more coactive shifts, and/or wherein the time interval is adaptable and determined for each coactive shift in use of the bicycle.

26.-40. (canceled)

41. A bicycle transmission system comprising:
a first transmission having at least two different transmission ratios,
a second transmission having at least two different transmission ratios,
wherein the first transmission and the second transmission are connected to each other in series to form a bicycle transmission that is selectively operable according to a plurality of different bicycle transmission ratios, and
an actuation unit configured for, upon receiving an upshift input, upshifting the bicycle transmission according to an upshift sequence,
wherein the upshift sequence comprises one or more coactive shifts of upshifting the bicycle transmission by coactively downshifting a first one of the first transmission and the second transmission and upshifting a second one of the first transmission and the second transmission,
wherein the actuation unit is configured for, for one or more of the one or more coactive shifts of the upshift sequence, downshifting, or at least triggering downshifting of, the first one of the first transmission and the second transmission and subsequently upshifting, or at least triggering upshifting of, the second one of the first transmission and the second transmission.

42. A bicycle transmission system comprising:
a first transmission having at least two different transmission ratios,
a second transmission having at least two different transmission ratios,
wherein the first transmission and the second transmission are connected to each other in series to form a bicycle transmission that is selectively operable according to a plurality of different bicycle transmission ratios, and
an actuation unit configured for, upon receiving a downshift input, downshifting the bicycle transmission according to a downshift sequence,
wherein the downshift sequence comprises one or more coactive shifts of downshifting the bicycle transmission by coactively downshifting a first one of the first transmission and the second transmission and upshifting a second one of the first transmission and the second transmission,
wherein the actuation unit is configured for, for one or more of the one or more coactive shifts of the downshift sequence, upshifting, or at least triggering upshifting of, the first one of the first transmission and the second transmission and subsequently downshifting, or at least triggering downshifting of, the second one of the first transmission and the second transmission.

43. The bicycle transmission system of claim 41, wherein the first one of the first transmission and the second transmission has a smaller transmission ratio step size between adjacent transmission ratios than the second one of the first transmission and the second transmission.

44. The bicycle transmission system of claim 41, wherein the first transmission has one or more first clutches and/or brakes for shifting the first transmission between at least two different transmission ratios, and one or more first actuators for actuating the one or more first clutches and/or brakes.

45. The bicycle transmission system of claim 44, wherein the first transmission comprises one or more first planetary gear sets, each having at least three rotatable members, optionally wherein one of the one or more first clutches and/or brakes is configured for coupling a first rotatable member of one of the one or more first planetary gear sets with a second rotatable member of the one of the one or more first planetary gear sets.

46.-57. (canceled)

58. The bicycle transmission system of claim 41, wherein the actuation unit is further configured for, upon receiving a downshift input, downshifting the bicycle transmission according to a downshift sequence,
wherein the downshift sequence comprises one or more coactive shifts of downshifting the bicycle transmission by coactively downshifting a first one of the first transmission and the second transmission and upshifting a second one of the first transmission and the second transmission,
wherein the actuation unit is configured for, for one or more of the one or more coactive shifts of the downshift sequence, upshifting, or at least triggering upshifting of, the first one of the first transmission and the second transmission and subsequently downshifting, or at least triggering downshifting of, the second one of the first transmission and the second transmission.

59. The bicycle transmission system of claim 44, wherein:
the first transmission comprises a first rotational input member, a first rotational output member and a first further rotational member, and is configured for transmitting torque according to an overdrive transmission ratio between the first rotational input member and the first rotational output member;
the first transmission comprises a second rotational input member, a second rotational output member and a second further rotational member, and configured for transmitting torque according to an underdrive transmission ratio between the second rotational input member and the second rotational output member;
the first and second rotational input members are corotatingly fixed to each other, and the first and second rotational output members are corotatingly fixed to each other; and
the one or more first clutches and/or brakes are arranged for selectively clutching at least one of the first further rotational member and the second further rotational member to a stationary part, for selectively transmitting torque through the first transmission or through the second transmission.

60.-68. (canceled)
